(19) United States
(12) Patent Application Publication
(10) Pub. No.: US 2024/0121056 A1
(43) Pub. Date: Apr. 11, 2024

(54) DEMODULATION REFERENCE SIGNAL PORT MAPPING AND INDICATION SCHEMES

(71) Applicant: ZTE Corporation, Shenzhen, Guangdong (CN)

(72) Inventors: Meng MEI, Shenzhen (CN); Bo GAO, Shenzhen (CN); Yang ZHANG, Shenzhen (CN); Ke YAO, Shenzhen (CN)

(21) Appl. No.: 18/527,002

(22) Filed: Dec. 1, 2023

Related U.S. Application Data
(63) Continuation of application No. PCT/CN2022/122955, filed on Sep. 29, 2022.

(51) Int. Cl. H04L 5/00; H04J 13/00; H04W 72/1263

(52) U.S. Cl. CPC H04L 5/0051; H04J 13/004; H04L 5/0016; H04W 72/1263

(57) ABSTRACT

Methods, systems, and devices related to wireless communication are described. One example method of wireless communication includes receiving, by a communication device, a reference signal indication. The method further includes demodulating, by the communication device, the reference signal based on a plurality of resources associated with the reference signal indication.

### CROSS-REFERENCE TO RELATED APPLICATION

This application is a continuation and claims priority to International Application No. PCT/CN2022/122955, filed on Sep. 29, 2022, the disclosure of which is hereby incorporated by reference herein in its entirety.

### TECHNICAL FIELD

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to demodulation reference signal (DMRS) design.

In one example aspect, a wireless communication method is disclosed. The method includes receiving, by a communication device, a reference signal indication; and demodulating, by the communication device, the reference signal based on a plurality of resources associated with the reference signal indication.

In another example aspect, another wireless communication method is disclosed. The method includes transmitting, by a network device to a communication device a reference signal indication; wherein the reference signal indication indicates a plurality of resources that enable the communication device to demodulate the reference signal.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 illustrates DMRS type 2 with one front loaded DMRS symbols.

FIG. 2 illustrates DMRS type 2 with two front loaded DMRS symbols.

FIG. 3 illustrates DMRS type 2 with one front loaded and two additional DMRS symbols.

FIG. 4 illustrates DMRS CDM groups with 4 DMRS ports in one CDM group.

FIG. 5 illustrates DMRS CDM groups with 4 DMRS ports in one CDM group for DMRS type 1.

FIG. 6 is a flowchart illustrating an example method.

FIG. 7 is a flowchart illustrating an example method.

FIG. 8 is a block diagram example of a wireless communication system.

FIG. 9 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

In the initial releases of new radio (NR), two demodulation reference signal (DMRS) types are supported named as DMRS type 1 and DMRS type 2.

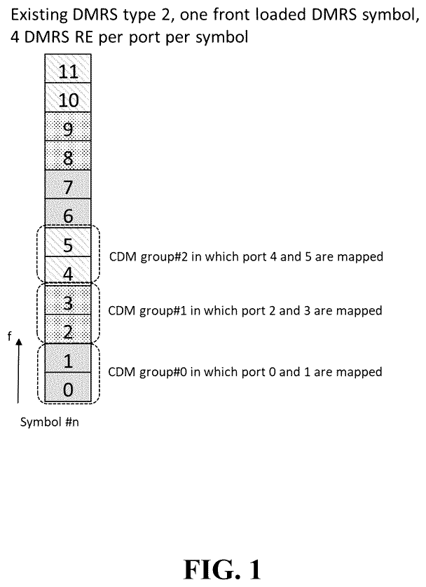

FIG. 1 shows the DMRS pattern for DMRS type 2 within one physical resource block (PRB) in the case when one front loaded DMRS symbol is configured by radio resource control (RRC) signaling or indicated by downlink control information (DCI) signaling, where two adjacent frequency resource elements (REs) form one DMRS code division multiplexing (CDM) group.

Specifically, DMRS port 0 and 1 are multiplexed in CDM group #0, i.e., port 0 and portl are multiplexed in RE #0 and RE #1 in CDM manner, and port 0 and port 1 are also multiplexed in RE #6 and RE #7 in CDM manner. As seen in FIG. 1, CDM group #0 are repeated twice where one is in RE #0 and #1, and the other one is in RE #6 and #7 Similar mapping for other DMRS ports. In summary, 6 DMRS ports are supported in the case of one front loaded DMRS symbol, and the density of each DMRS port is 4 REs per PRB per symbol.

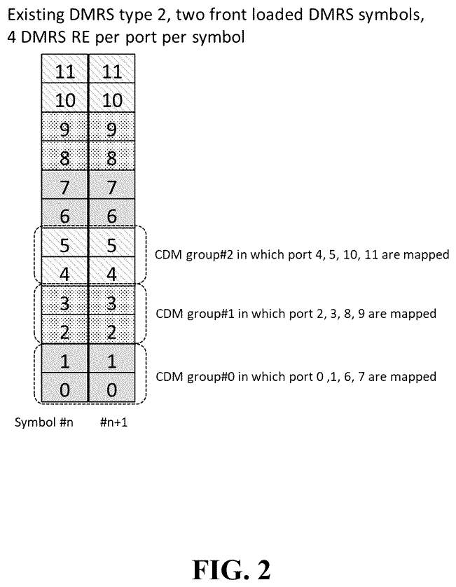

FIG. 2 shows the DMRS pattern for DMRS type 2 within one PRB in the case when two front loaded DMRS symbols are configured by RRC signaling or indicated by DCI signaling, where four adjacent REs form one DMRS CDM group.

Specifically, DMRS port 0, 1, 6 and 7 are multiplexed in CDM group #0 in CDM manner Similar mapping for other DMRS ports. In summary, 12 DMRS ports are supported in the case of two front loaded DMRS symbols, and the density of each DMRS port is 8 REs per PRB per 2-symbols. Note that in one PRB, each CDM group maps twice, e.g., CDM group #0 maps on RE #0, #1 and also RE #6, #7.

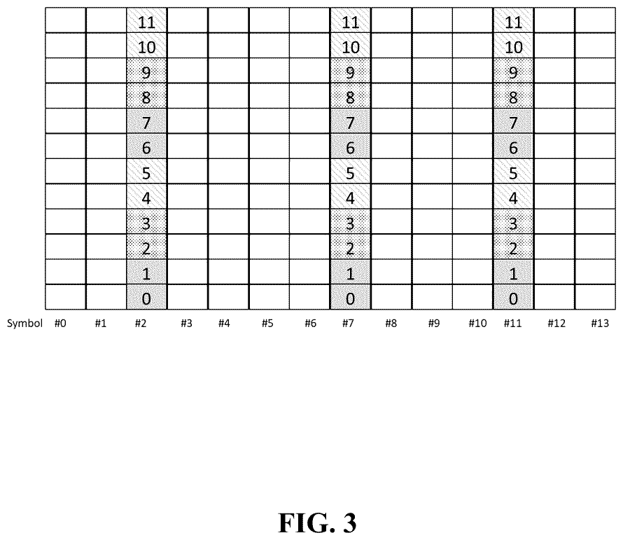

FIG. 3 shows one front loaded DMRS symbol and X=0, 1, 2 additional DMRS symbol can be configured.

In the uplink or downlink transmission, more than 8 or 12 DMRS ports may be supported. New DMRS pattern should be designed, and the DMRS port should also be indicated to UE. In current specification, only 8 or 12 DMRS ports are supported, and how to support more DMRS ports should be considered.

### EMBODIMENT 1

User equipment (UE) receives a reference signal indication from gNB and acquire and demodulate the reference signal from plurality of resources.

One DMRS port can be associated with orthogonal cover code (OCC) of length 4 or 6 in the frequency domain, and up to 4 or 6 DMRS ports can be mapped on the same resources by using different OCC.

For DMRS mapping, the frequency domain OCC with length 4 can be used and 4 resource elements can be used for one CDM group mapping or one OCC with length 4 mapping.

The DMRS mapping is associated with plurality parameter, such as from at least one of: the PRB index for one scheduling or in one PRG, the repetition number of CDM group, the RE index, the DMRS port index, and the related OCC index.

The sequence shall be mapped to the intermediate quantity a_{k,l}^{(p,μ)} according to

a_{k,l}^{(p,μ)}=w_{f}(k′)wₜ(l′)r(4*n+k′)

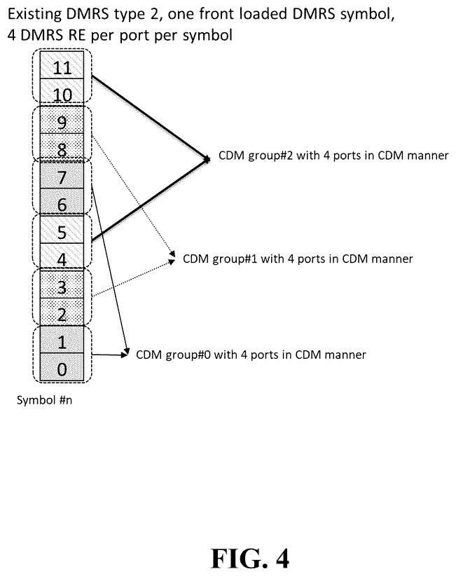

As shown in FIG. 4 of DMRS type 2, 4 REs are supported for one CDM group for single symbol DMRS mapping, and one DMRS port with OCC of length 4 can be used.

For DMRS type 2, 3 CDM groups are used for DMRS mapping, and the DMRS ports of the first CDM group are mapped on REs #0, 1, 6, 7, and the related parameter for DMRS mapping which is represented by k′ and RE indexes are associated with the parameter k′, such that k′=0,1,6,7.

Considering DMRS type 2, up to 3 DMRS CDM groups are supported, and the 3 CDM groups are mapped on different resources, a parameter is associated with different CDM groups and determined by the start RE index of the mapping of each CDM group. Regardless of OCC in time domain, for DMRS type 2, the CDM group #0, 1, 3 are associated with 4 ports in CDM manner, as shown in FIG. 4.

For DMRS type 2, the DMRS can be mapped on the frequency resource elements of:

k=a*n+b*k′+Δ

The parameter k′, the associate resource elements in one CDM group, and the start resource elements index for each CDM group respectively are discussed above.

The parameter a represents the difference of REs between two times of DMRS mapping for the same CDM group or it can be described as the total number of REs that used for mapping the number of CDM groups or the total number of DMRS ports supported in one OFDM symbol and the parameter n represents different times of DMRS mapping for the same CDM group.

Take type 2 DMRS for example, each CDM group is mapped on 4 different REs, and for up to 3 CDM groups, a total number of 12 REs are used for the CDM groups. So, for the same CDM group mapping, different 12 REs are supported, the value a equals to 12, and n can be a integer value from 0. The formula can be modified as k=12*n+k′Δ.

For the first time of DMRS CDM group mapping, i.e., n=0

For CDM group #0, k′=0,1,6,7, and Δ=0, CDM group 0 are mapped on REs #0,1,6,7.

For CDM group #1, k′=0,1,6,7, and Δ=2, CDM group 1 are mapped on REs #2,3,8,9.

For CDM group #2, k′=0,1,6,7, and Δ=2, CDM group 2 are mapped on REs #4,5,10,11.

All of the REs in one PRB are used for the DMRS mapping for the up to 3 DMRS CDM groups.

Similarly, for the other value of n, the REs of other PRBs are used for the DMRS mapping.

### EMBODIMENT 2

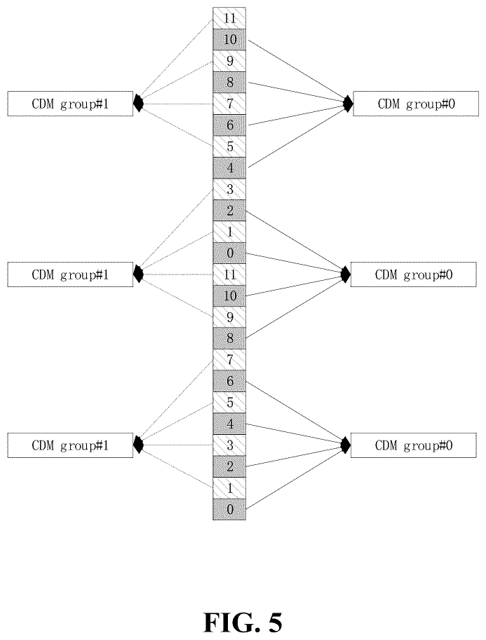

As shown in FIG. 5 of DMRS type 1 DMRS, up to 2 CDM groups are supported, if the frequency domain orthogonal cover codes (FD-OCC) is supported as length 4. 4 from the total 6 REs are used for the DMRS ports mapping of one CDM group in one PRB and the other 2 REs are used for the DMRS mapping combined with 2 REs from the consecutive PRB for one CDM group mapping, or it can be called PRB bundling for the consecutive PRBs for all the scheduled PRBs or the PRBs in one PRG.

Similarly for type 1 DMRS mapping, regardless of the time domain OCC, some parameters should be determined for the frequency domain resource mapping.

For DMRS type 1, 2 CDM groups are used for DMRS mapping, and the DMRS ports of the first CDM group are mapped on REs #0,2,4,6, and the related parameter for DMRS mapping which is represented by k′ and the RE indexes are associated with the parameter k′, such that k′=0,2,4,6

Considering for DMRS type 1, up to 2 DMRS CDM groups are supported, and the 2 CDM groups are mapped on different resources, a parameter of Δ is associated with different CDM groups and determined by the start RE index of the mapping of each CDM group. Regardless of OCC in the time domain, for DMRS type 2, the CDM group #0, 1 are associated with 4 ports in CDM manner, as shown in FIG. 5.

For DMRS type 1, the DMRS can be mapped on the frequency resource elements of:

k=a*n+b*k′+Δ

The parameter k′, the associate resource elements in one CDM group, and the start resource elements index for each CDM group respectively are discussed above.

The parameter a represents the difference of the REs between two times of DMRS mapping for the same CDM group or it can be described as the total number of REs that used for mapping the number of CDM groups or the total number of DMRS ports supported in one OFDM symbol and the parameter n represents different times of DMRS mapping for the same CDM group.

Take type 1 DMRS for example, each CDM group is mapped on 4 different REs, and for the up to 2 CDM groups, a total number of 8 REs are used for the CDM groups. So, for the same CDM group mapping, a difference of 8 REs are supported, the value a equals to 8, and n can be a integer value from 0. The formula can be modified to k=8*n +k′+Δ.

For the first time of DMRS CDM group mapping, i.e., n=0

For CDM group #0, k′=0,2,4,6, and Δ=0, CDM group 0 are mapped on REs #0,2,4,6.

For CDM group #1, k′=0,2,4,6, and Δ=1, CDM group 1 are mapped on REs #1,3,5,7.

For the second time of DMRS CDM group mapping, i.e., n=1

For CDM group #0, k′=0,2,4,6, and Δ=0, CDM group 0 are mapped on REs #8,10,12,14.

For CDM group #1, k′=0,2,4,6, and Δ=1, CDM group 1 are mapped on REs #9,11,13,15.

For the third time of DMRS CDM group mapping, i.e., n=2

For CDM group #0, k′=0,2,4,6, and Δ=0, CDM group 0 are mapped on REs #16,18,20,22.

For CDM group #1, k′=0,2,4,6, and Δ=1, CDM group 1 are mapped on REs #17,19,21,23.

As shown in FIG. 5, REs #0-11 are allocated as the first PRB, and REs #12-23 are allocated as the second PRB, which are the REs #0-11of the second PRB.

For DMRS type 1, two PRB can be bundled for the DMRS port mapping, and three times mapping are supported for each CDM group in the two PRBs.

In the case of an even number of PRBs are scheduled for a PDSCH/PUSCH transmission or in one PRG, a and n are associated with the total number of REs of these PRBs, e.g., n=0,1, . . . floor(numberofREs/a)−1.

In the case of odd number of PRBs are scheduled for a PDSCH/PUSCH transmission or in one PRG, the last plurality REs of the last PRB may not be used for the DMRS mapping, so for the determination of a and n, these REs should not be considered, i.e., n=0,1, . . . floor(numberofREs/a)−1. The numberofREs should be all of the REs except for the plurality REs of the last PRB.

In the case of odd number of PRBs are scheduled for a PDSCH/PUSCH transmission or in one PRG, the last plurality REs of the last PRB may not be used for the DMRS demodulation but can still be mapped from the transmission point. Thus, for the determination of a and n, these REs should also be considered, i.e., n=0,1, . . . ,ceil(numberofREs/a)−1. The numberofREs should be all the REs except for the plurality REs of the last PRB.

In the case of odd number of PRBs are scheduled for a PDSCH/PUSCH transmission or in one PRG, the last PRB may not be used for the DMRS mapping, so for the determination of a and n, these REs in the last PRB should not be considered, i.e., n=0,1, . . . ,numberofREs/a, in this case, the numberofREs should be determined by the scheduled PRB number for a PDSCH/PUSCH or a PRG except for the one PRB, e.g., the last PRB.

so the intermediate quantity ã_{k,l}^{(\tilde{p}j,μ)} of DMRS can be determined by

$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I & {k}^{′} = 0 , 2 , 4 , 6 ; \\ 12 * n + {k}^{′} + Δ , configration type II & {k}^{′} = 0 , 1 , 6 , 7 ;\end{matrix} \\ l = \overline{l} + {l}^{′} \\ n = 0 , 1 … \\ j = 0 , 1 , … , v - 1\end{matrix}$$

The parameters in the formula indicate the frequency domain and time domain resource. One DMRS RS port is mapped onto 2 REs of one PRB on one OFDM symbol as shown in FIG. 4. It can be found one DMRS port is mapped on two REs onto one PRB with a frequency domain OCC. The parameters w_{f}(k′) and w_{f}(l′) are the OCC in the frequency domain and time domain r(2n+k′) is the sequence of the DMRS port.

In the case of the DMRS is mapped within one PRB, and for DMRS type 1, if FD-OCC=6 is supported, the parameter k for DMRS configuration type 1 should be modified as:

k=12*n+k′+Δ k′=0,2,4,6,8,10

### EMBODIMENT 3

Considering the parameter k′ also is associated with the sequence generation of r(2n+k′), and if a unified design is supported of k′ is supported for type 1 and type 2 DMRS, e.g., k′=0,1,2,3, so for DMRS type 1, the formula of k should be modified as k=8*n+2*k′+Δ and for DMRS type 2, from the mapping pattern as shown in FIG. 4, k should be 0,1,6,7 in this PRB, and if k′=0,1,2,3, parameter k should be calculated from k′.

So the formula for type 2 DMRS should be k=12*n+(k′+c)+Δ, in the case of k′=0,1, c=0, in the case of k′=2,3, c=4.

Therefore, the intermediate quantity ã_{k,l}^{(\tilde{p}j,μ)} of DMRS can be determined by

$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I \\ 12 * n + {k}^{′} + Δ , configration type II\end{matrix} \\ {k}^{′} = 0 , 1 , 2 , 3 \\ c = \{ \begin{matrix}0 & when {k}^{′} = 0 , 1 \\ 4 & when {k}^{′} = 2 , 3\end{matrix} \\ l = \overline{l} + {l}^{′} \\ n = 0 , 1 … \\ j = 0 , 1 , … , v - 1\end{matrix}$$

k′ and Δ are associated with the DMRS port index or CDM group index, as shown in table 1 and 2

TABLE 1
Parameters for PDSCH DM-RS configuration type 1.

| | |
|---|---|
| CDM | |
| group | w_{f} (k′) |

| p | λ | Δ | k′ = 0 | k′ = 1 | k′ = 2 | k′ = 3 |
|---|---|---|---|---|---|---|
| 0 | 0 | 0 | +1 | +1 | +1 | +1 |
| 1 | 0 | 0 | +1 | −1 | +1 | +1 |
| 2 | 0 | 0 | +1 | +1 | −1 | −1 |
| 3 | 0 | 0 | +1 | −1 | −1 | +1 |
| 4 | 1 | 1 | +1 | +1 | +1 | +1 |
| 5 | 1 | 1 | +1 | −1 | +1 | −1 |
| 6 | 1 | 1 | +1 | +1 | −1 | −1 |
| 7 | 1 | 1 | +1 | −1 | −1 | +1 |

TABLE 2
Parameters for PDSCH DM-RS configuration type 2.

| | |
|---|---|
| CDM | |
| group | w_{f} (k′) |

| p | λ | Δ | k′ = 0 | k′ = 1 | k′ = 2 | k′ = 3 |
|---|---|---|---|---|---|---|
| 0 | 0 | 0 | +1 | +1 | +1 | +1 |
| 1 | 0 | 0 | +1 | −1 | +1 | −1 |
| 2 | 0 | 0 | +1 | +1 | −1 | −1 |
| 3 | 0 | 0 | +1 | −1 | −1 | +1 |
| 4 | 1 | 2 | +1 | +1 | +1 | +1 |
| 5 | 1 | 2 | +1 | −1 | +1 | −1 |
| 6 | 1 | 2 | +1 | +1 | −1 | −1 |
| 7 | 1 | 2 | +1 | −1 | −1 | +1 |
| 8 | 2 | 4 | +1 | +1 | +1 | +1 |
| 9 | 2 | 4 | +1 | −1 | +1 | −1 |
| 10 | 2 | 4 | +1 | +1 | −1 | −1 |
| 11 | 2 | 4 | +1 | −1 | −1 | +1 |

### EMBODIMENT 4

The indication includes the association of phase tracking reference signal (PTRS)-DMRS for more than one physical uplink shared channel (PUSCH) transmission groups.

Each group is indicated with at least one DMRS port.

The UE is configured with one or more sounding reference signal (SRS) resource sets, which are configured in srs-ResourceSetToAddModList or srs-ResourceSetToAddModListDCI-0-2 with higher layer parameter usage in SRS-ResourceSet set to ‘codebook’ or ‘non-codebook’. Each group is associated with one SRS resource set. Each of PUSCH transmission group is associated with one SRS resource set and these PUSCH transmission group are associated with different beam states or spatial relations.

Each of these PUSCH transmissions groups at configured or indicated with different transmission layers (DMRS ports) and these PUSCH transmission group can be fully or partially overlapped in time domain and/or frequency domain.

For two groups of PUSCH transmission, in the case of two PTRS port is enabled, and the association of PTRS port and DMRS port should be indicated in the case of at least one PTRS port is shared by more than one DMRS port.

In the case of only one DMRS port is indicated or configured for each transmission group, and if PTRS is enabled, and the PTRS port is associated with the one DMRS port, and no indication is need.

If one DMRS port is indicated or configured for one PUSCH transmission group, and more than one DMRS ports are indicated for the other PUSCH transmission group, such as layer combinations {1+2, 2+1, 1+3, 3+1}, the association of PTRS port and DMRS port should be indicated for the PUSCH transmission group with more than one DMRS ports. If two DMRS ports are indicated for one PUSCH transmission group, 1 bit can be used for the indication of PTRS port and DMRS port of this group, and table 4-1 or table 4-2 or table 4-3 can be used for the indication of PTRS port and DRMS port. If three DMRS ports in one transmission group share one PTRS port 2 bits should be used to indicate the association of PTRS port and DMRS port and table 3 should be used.

Table 3 indicates the PTRS port x associated with the xth SRS resource set, or table 5 when PTRS port 0 associated with different SRS resource set.

TABLE 3
PTRS-DMRS association for UL PTRS port x

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

For layer combinations {2+2}, each PTRS port is share by the two DMRS ports and one bit should be used to indicated with DMRS port is associated with the PTRS port. For example, 1st bit in PTRS-DMRS association indicates the DMRS port associated PTRS port 0 and 2nd bit in PTRS-DMRS association indicates the DMRS port associated with PTRS port 1 for each PUSCH transmission group.

Table 4 indicates PTRS port is configured across these PUSCH transmission groups, and a total number of 2 PTRS ports are configured as PTRS port 0 and 1.

TABLE 4
PTRS-DMRS association for UL PTRS ports 0 and 1

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

In the case of the two PTRS port 0 is configured or indicated and each PTRS port is associated with one SRS resource set. The indicated of PTRS port and DMRS port association can be shown in Table 5.

TABLE 5
PTRS-DMRS association for UL PTRS port 0 or for the actual UL PT-RS port

| Value of | | Value of | |
|---|---|---|---|
| MSB | DMRS port | LSB | DMRS port |
| 0 | 1^{st} scheduled DMRS port | 0 | 1st scheduled DMRS port |
| | corresponding to SRS | | corresponding to Second SRS |
| | resource indicator field and/or | | resource indicator field and/or |
| | Precoding information and | | Second Precoding information |
| | number of layers field | | field |
| 1 | 2^{nd} scheduled DMRS port | 1 | 2nd scheduled DMRS port |
| | corresponding to SRS | | corresponding to Second SRS |
| | resource indicator field and/or | | resource indicator field and/or |
| | Precoding information and | | Second Precoding information |
| | number of layers field | | field |

For the case of more than 2 PTRS port are configured for all the PUSCH transmission groups or up to 2 PTRS ports is supported for at least one PUSCH transmission group, the association of PTRS port and DMRS port of only the group with 1 PTRS port should be indicated, and 2 bits can be used as shown in table 3 or 1 bit is used as shown in table 4 or 5 for this group.

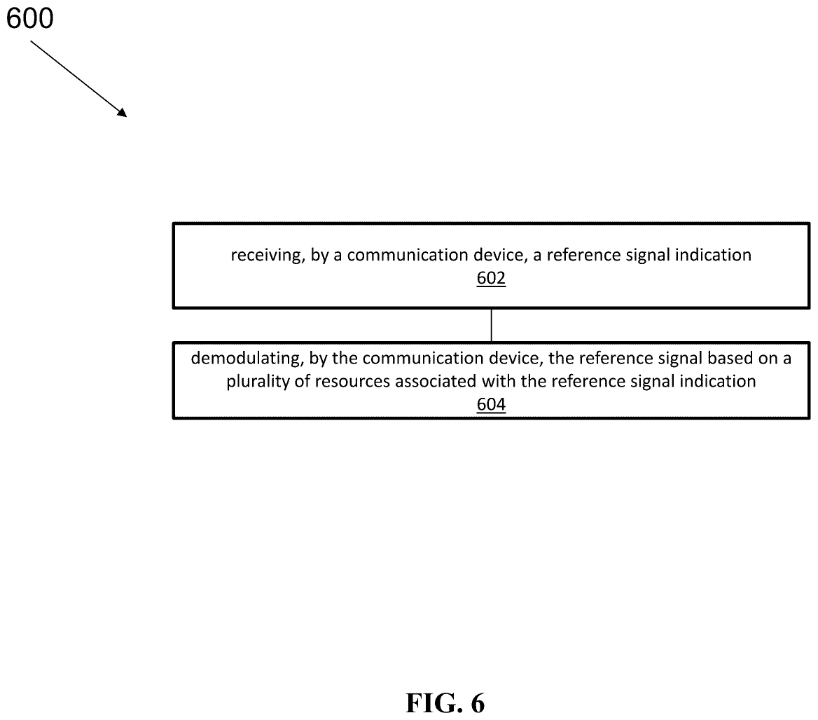

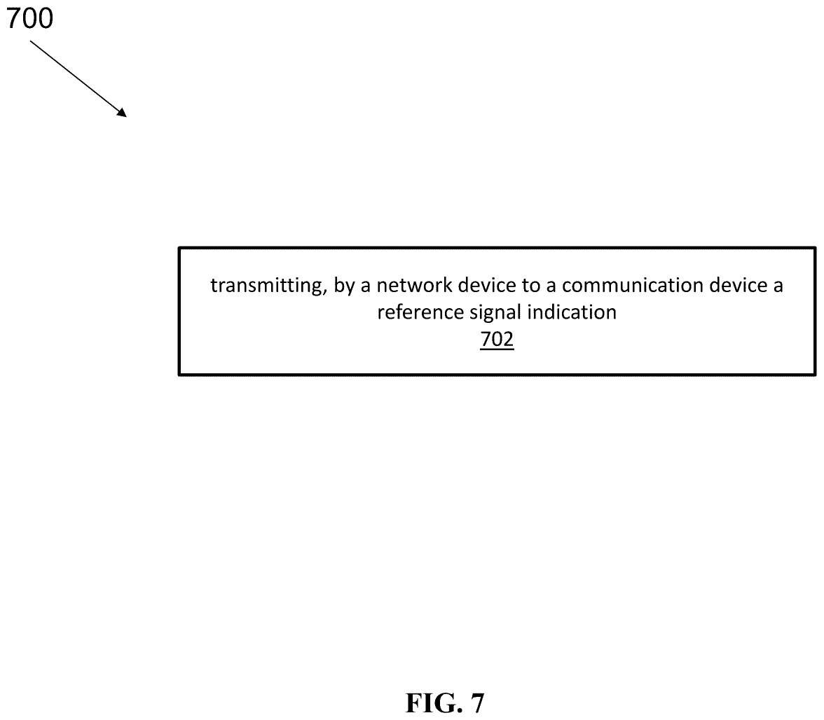

In the case of 3 DMRS ports are configured or indicated for one PUSCH group, if two PTRS ports are supported in this group, that one PTRS port is shared by one DMRS port and the other PTRS port is shared by the other two DMRS ports, and the association of this PTRS port and the shared two DMRS port should be indicated, such as in table 5. in the case of 4 PTRS ports are supported, and 4 DMRS ports are indicated, on indication is needed.
1. A method of wireless communication, as disclosed in FIG. 6, including receiving, by a communication device, a reference signal indication (602); and demodulating, by the communication device, the reference signal based on a plurality of resources associated with the reference signal indication (604). Additional details and examples are discussed with respect to Embodiment 1.
2. The method of solution 1, wherein the plurality of resources are associated with at least one of: a generated sequence, a resource element or a subcarrier in a frequency domain, a demodulation reference signal (DMRS) port, a number of orthogonal DMRS ports in one code division multiplexing (CDM) group, a total number of orthogonal DMRS ports for all CDM groups, a configured DMRS type, an orthogonal cover code (OCC) length, resource elements offset in one CDM group, an OCC related information in the frequency domain, or an OCC related information in the time domain.
3. The method of solution 1, wherein the DMRS port are supported as DMRS type 1 and DMRS type 2.
4. The method of solution 2, wherein the generated sequence is based on r(x*n+k′); and wherein x and k′ are associated with at least one of: the number of orthogonal DMRS ports in one CDM group, the OCC length in the frequency domain, or the total number of DMRS ports for all the CDM groups in one OFDM symbol.
5. The method of solution 4, wherein the number of orthogonal DMRS ports in one CDM group or the OCC length in the frequency domain is 4 or 6.
6. The method of solution 5, wherein the generated sequence is further generated according to r(4*n+k′).
7. The method of solution 1, wherein the resource element or the subcarrier in the frequency domain is determined based on an equation: k=a*n+b*k+c+Δ wherein k is an index of the resource elements or the subcarriers, a and b are associated with the number of CDM groups or the number of DMRS ports or the configured DMRS type, k′ and Δ are associated with a DMRS port index or a CDM group index, n is a serial integer from 0.
8. The method of solution 7, wherein a further associates with one of: the difference of the resource elements between two times of DMRS mapping for the same CDM group, the total number of resource elements used for mapping the number of CDM groups, or the total number of DMRS ports supported in one OFDM (Orthogonal Frequency Division Multiplexing) symbol.
9. The method of solution 7, wherein the parameters are further determined from at least one of: for DMRS type 1, frequency domain orthogonal cover codes (FD-OCC) length is 4, a=8, b=2, c=0, then Δ=0 for the first CDM group and Δ=1 for the second CDM group, or for DMRS type 2, FD-OCC length is 4, a=12, b=1, c=0 or 4, then Δ=0 for the first CDM group, Δ=2 for the second CDM group, and Δ=4 for the third CDM group.
10. The method of solution 7, wherein n is represented as n=0,1, . . . ,floor(numberofREs/a)−1; or n=0,1, . . . ,ceil(numberofREs/a−1); wherein the numberofREs is at least one of: a total number of resource elements or subcarriers for an uplink or downlink transmission scheduling, a total number of resource elements in a precoding resource block group (PRG), a total number of resource elements or subcarriers for an uplink or downlink transmission scheduling, or a total number of resource elements in a precoding resource block group (PRG) except for the last plurality resource elements.
11. The method of solution 7, Wherein k′ is presented as k′=0,1,2,3 when FD-OCC length is 4.
12. The method of solution 7, Wherein DMRS type 1 is based on k′=0,1 and c=0, DMRS type 2 is based on k′=2,3 and c=4.
13. The method of claim 4, wherein the resource element or the subcarrier in the frequency domain is mapped to the intermediate quantity a_{k,l}^{(p,μ)} on at least one of the equations:

$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I \\ 12 * n + {k}^{′} + Δ , configration type II\end{matrix} \\ {k}^{′} = 0 , 1 , 2 , 3 \\ c = \{ \begin{matrix}0 & when {k}^{′} = 0 , 1 \\ 4 & when {k}^{′} = 2 , 3\end{matrix} \\ l = \overline{l} + {l}^{′} \\ n = 0 , 1 … \\ j = 0 , 1 , … , v - 1\end{matrix}$$

$$or$$

$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I & {k}^{′} = 0 , 2 , 4 , 6 ; \\ 12 * n + {k}^{′} + Δ , configration type II & {k}^{′} = 0 , 1 , 6 , 7 ;\end{matrix} \\ l = \overline{l} + {l}^{′} \\ n = 0 , 1 … \\ j = 0 , 1 , … , v - 1\end{matrix}$$

wherein k is an index of resource elements or subcarrier, b is associated with the number of CDM groups or the configured DMRS type, k′ represents DMRS mapping parameter, n represents different times of DMRS mapping for the same CDM group, Δ is associated to an index of a CDM group or a DMRS port, w_{f}(k′) and w_{f}(l′) are OCC parameters in frequency domain and time domain, and r(4*n+k′) is the resource sequence of the DMRS port.
14. The method of solution 1, wherein the reference signal indication further comprising an association of a phase tracking reference signal (PTRS)-DMRS for one or more physical uplink shared channel (PUSCH) transmission groups.
15. The method of solution 12, wherein each of the PUSCH transmission group is indicated with at least a DMRS port and is associated with a sounding reference signal (SRS) resource set; wherein the one or more PUSCH transmission groups are fully or partially overlapped with time domain or frequency domain or both; and wherein the one or more PUSCH transmission groups are associated with different beam states or spatial relations respectively.
16. The method of solutions 2 and 12, wherein one or more DMRS port shares per PTRS port per PUSCH transmission group; and wherein the PTRS port and the DMRS port associations are indicated.
17. The method of solution 14, wherein the number of PTRS ports is the same as the number of DMRS ports in the one or more PUSCH transmission groups; and wherein the PTRS port and the DMRS port associations are not indicated.
18. The method of solutions 2 and 12, wherein the association of PTRS-DMRS for one or more PUSCH transmission groups is indicated by a number of bits used; and wherein when 2 DMRS ports share one PTRS port in one PUSCH transmission group.
19. The method of solution 16, wherein 2 bits are used to indicate the association of PTRS-DMRS when more than 2 DMRS ports share one PTRS port in one PUSCH transmission group.
20. A method of wireless communication, as disclosed in FIG. 7, including transmitting, by a network device to a communication device a reference signal indication (702); wherein the reference signal indication indicates a plurality of resources that enable the communication device to demodulate the reference signal. Additional details and examples are discussed with respect to Embodiment 1.
21. The method of solution 20, wherein the plurality of resources are associated with at least one of: a generated sequence, a resource element or the subcarrier in a frequency domain, a demodulation reference signal (DMRS) port, a number of orthogonal DMRS ports in one code division multiplexing (CDM) group, a total number of orthogonal DMRS ports for all CDM groups, a configured DMRS type, an orthogonal cover code (OCC) length, resource elements offset in one CDM group, an OCC related information in the frequency domain, or an OCC related information in the time domain.
22. The method of solution 20, wherein the DMRS port are supported as DMRS type 1 and DMRS type 2.
23. The method of solution 21, wherein the generated sequence is based on r(x*n+k′); and wherein x and k′ are associated with at least one of: the number of orthogonal DMRS ports in one CDM group, the OCC length in the frequency domain, or the total number of DMRS ports for all the CDM groups in one OFDM symbol.
24. The method of solution 23, wherein the number of orthogonal DMRS ports in one CDM group or the OCC length in the frequency domain is 4 or 6.
25. The method of solution 24, wherein the generated sequence is further generated according to r(4*n+k′).
26. The method of solution 20, wherein the resource element or the subcarrier in the frequency domain is determined based on an equation: k=a*n+b*k +c+Δ; wherein k is an index of the resource elements or the subcarriers, a and b are associated with the number of CDM groups or the number of DMRS ports or the configured DMRS type, k′ and Δ are associated with a DMRS port index or a CDM group index, n is a serial integer from 0.
27. The method of solution 26, wherein a further associates with one of: the difference of the resource elements between two times of DMRS mapping for the same CDM group, the total number of resource elements used for mapping the number of CDM groups, or the total number of DMRS ports supported in one OFDM (Orthogonal Frequency Division Multiplexing) symbol.
28. The method of solution 26, wherein the parameters are further determined from at least one of: for DMRS type 1, frequency domain orthogonal cover codes (FD-OCC) length is 4, a=8, b=2, c=0, then Δ=0 for the first CDM group and Δ=1 for the second CDM group, or for DMRS type 2, FD-OCC length is 4, a=12, b=1, c=0 or 4, then Δ=0 for the first CDM group, Δ=2 for the second CDM group, and Δ=4 for the third CDM group.
29. The method of solution 26, wherein n is represented as n=0,1, . . . ,floor(numberofREs/a)−1; or n=0,1, . . . ,ceil(numberofREs/a−1); wherein the numberofREs is at least one of: a total number of resource elements or subcarriers for an uplink or downlink transmission scheduling, a total number of resource elements in a precoding resource block group (PRG), a total number of resource elements or subcarriers for an uplink or downlink transmission scheduling, or a total number of resource elements in a precoding resource block group (PRG) except for the last plurality resource elements.
30. The method of solution 26, Wherein k′ is presented as k′=0,1,2,3 when FD-OCC length is 4.
31. The method of solution 26, Wherein DMRS type 1 is based on k′=0,1 and c=0, DMRS type 2 is based on k′=2,3 and c=4.
32. The method of solution 23, wherein the resource element or the subcarrier in the frequency domain is mapped to the intermediate quantity a_{k,l}^{(p,μ)} on at least one of the equations:

$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I \\ 12 * n + {k}^{′} + Δ , configration type II\end{matrix} \\ {k}^{′} = 0 , 1 , 2 , 3 \\ c = \{ \begin{matrix}0 & when {k}^{′} = 0 , 1 \\ 4 & when {k}^{′} = 2 , 3\end{matrix} \\ l = \overline{l} + {l}^{′} \\ n = 0 , 1 … \\ j = 0 , 1 , … , v - 1\end{matrix}$$

$$or$$

$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I & {k}^{′} = 0 , 2 , 4 , 6 ; \\ 12 * n + {k}^{′} + Δ , configration type II & {k}^{′} = 0 , 1 , 6 , 7 ;\end{matrix} \\ l = \overline{l} + {l}^{′} \\ n = 0 , 1 … \\ j = 0 , 1 , … , v - 1\end{matrix}$$

wherein k is an index of resource elements or subcarrier, b is associated with the number of CDM groups or the configured DMRS type, k′ represents DMRS mapping parameter, n represents different times of DMRS mapping for the same CDM group, Δ is associated to an index of a CDM group or a DMRS port, w_{f}(k′) and w_{f}(l′) are OCC parameters in frequency domain and time domain, and r(4*n+k′) is the resource sequence of the DMRS port.
33. The method of solution 20, wherein the reference signal indication further comprising an association of phase tracking reference signal (PTRS)-DMRS for one or more physical uplink shared channel (PUSCH) transmission groups.
34. The method of solution 31, wherein each of the PUSCH transmission group is indicated with at least a DMRS port and is associated with a sounding reference signal (SRS) resource set; wherein the one or more PUSCH transmission groups are fully or partially overlapped with time domain or frequency domain or both; and wherein the one or more PUSCH transmission groups are associated with different beam states or spatial relations respectively.
35. The method of claims 21 and 31, one or more DMRS port shares per PTRS port per PUSCH transmission group; and wherein the PTRS port and the DMRS port associations are indicated.
36. The method of solution 33, wherein the number of PTRS ports is the same as the number of DMRS ports in the one or more PUSCH transmission groups; and wherein the PTRS port and the DMRS port associations are not indicated.
37. The method of solutions 21 and 31, wherein the association of PTRS-DMRS for one or more PUSCH transmission groups is indicated by a number of bits used; wherein when 2 DMRS ports share one PTRS port in one PUSCH transmission group.
38. The method of solution 35, wherein 2 bits are used to indicate the association of PTRS-DMRS when more than 2 DMRS ports share one PTRS port in one PUSCH transmission group.
39. A communication apparatus comprising a processor configured to implement a method recited in any one or more of solutions 1 to 38.
40. A computer readable medium having code stored thereon, the code, when executed, causing a processor to implement a method recited in any one or more of solutions 1 to 38.

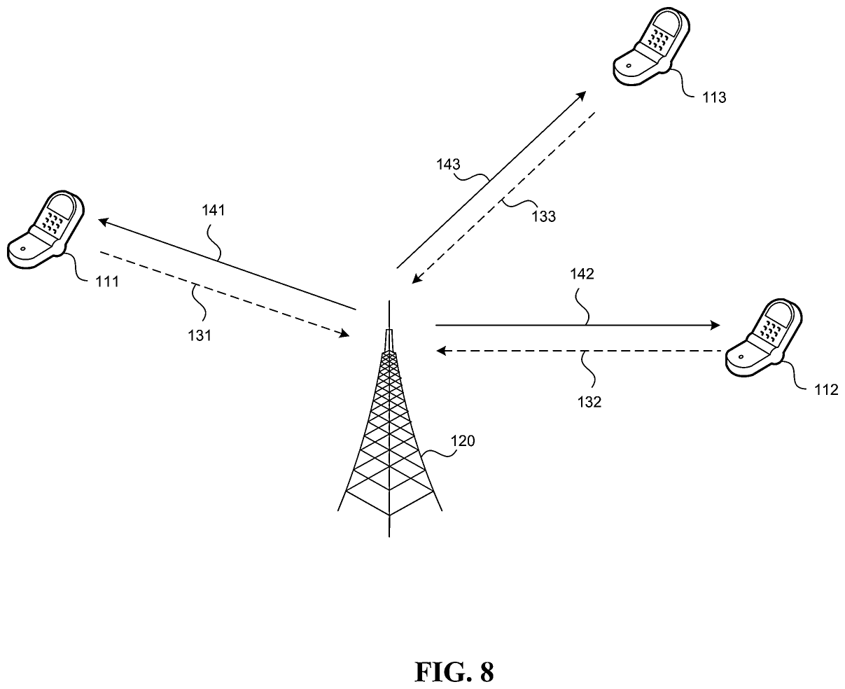

FIG. 8 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

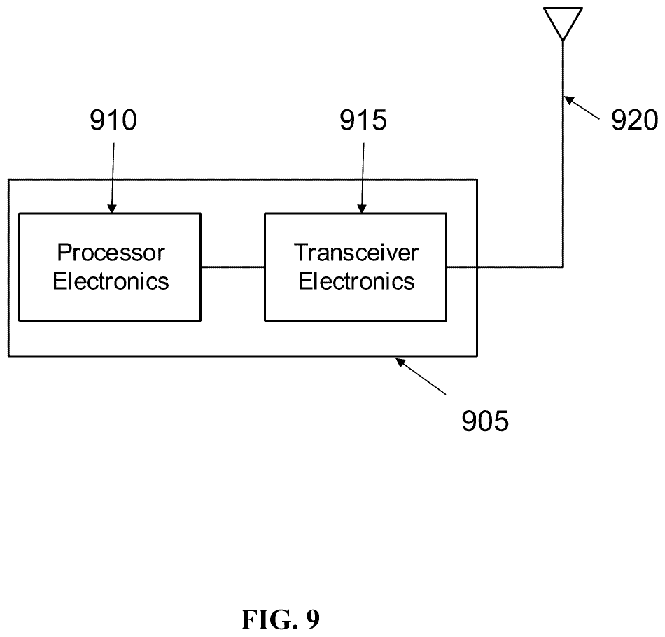

FIG. 9 is a block diagram representation of a portion of an apparatus, in accordance with some embodiments of the presently disclosed technology. An apparatus 905 such as a network device or a base station or a wireless device (or UE), can include processor electronics 910 such as a microprocessor that implements one or more of the techniques presented in this document. The apparatus 905 can include transceiver electronics 915 to send and/or receive wireless signals over one or more communication interfaces such as antenna(s) 920. The apparatus 905 can include other communication interfaces for transmitting and receiving data. Apparatus 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions are implemented using the apparatus 905.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
receiving, by a communication device, a reference signal indication; and
demodulating, by the communication device, the reference signal based on a plurality of resources associated with the reference signal indication.

2. The method of claim 1,
wherein the plurality of resources are associated with at least one of: a generated sequence, a resource element or a subcarrier in a frequency domain, a demodulation reference signal (DMRS) port, a number of orthogonal DMRS ports in one code division multiplexing (CDM) group, a total number of orthogonal DMRS ports for all CDM groups, a configured DMRS type, an orthogonal cover code (OCC) length, resource elements offset in one CDM group, an OCC related information in the frequency domain, or an OCC related information in the time domain, and
wherein the DMRS port is supported as DMRS type 1 and DMRS type 2.

3. The method of claim 2,
wherein the generated sequence is based on r(x*n+k′),
wherein x and k′ are associated with at least one of: the number of orthogonal DMRS ports in one CDM group, the OCC length in the frequency domain, the total number of DMRS ports for all the CDM groups in one OFDM symbol, or a DMRS port index,
wherein the number of orthogonal DMRS ports in one CDM group or the OCC length in the frequency domain is 4, and
wherein the generated sequence is further generated according to r(4*n+k′).

4. The method of claim 1,
wherein the resource element or the subcarrier in the frequency domain is determined based on an equation: k=a*n+b*k′+c+4,
wherein k is an index of the resource elements or the subcarriers, a and b are associated with the number of CDM groups or the number of DMRS ports or the configured DMRS type, k′ and Δ are associated with a DMRS port index or a CDM group index, n is a serial integer from 0,
wherein the parameters are further determined from at least one of: for DMRS type 1, frequency domain orthogonal cover codes (FD-OCC) length is 4, a=8, b=2, c=0, then Δ=0 for the first CDM group and Δ=1 for the second CDM group, or for DMRS type 2, FD-OCC length is 4, a=12, b=1, c=0 or 4, then Δ=0 for the first CDM group, Δ=2 for the second CDM group, and Δ=4 for the third CDM group,
wherein k′ is presented as k′=0,1,2,3 when FD-OCC length is 4, and
wherein for DMRS type 2, c=0 is associated with k′=0,1 and c=4 is associated with k′=2,3.

5. The method of claim 4, wherein n is represented as n=0,1, . . . ,floor(numberofREs/a)−1; or n=0,1, . . . ,ceil(numberofREs/a−1); and
wherein the numberofREs is at least one of: a total number of resource elements or subcarriers for an uplink or downlink transmission scheduling, a total number of resource elements in a precoding resource block group (PRG), a total number of resource elements or subcarriers for an uplink or downlink transmission scheduling, or a total number of resource elements in a precoding resource block group (PRG) except for the last plurality resource elements.

6. The method of claim 3, wherein the resource element or the subcarrier in the frequency domain is mapped to the intermediate quantity a_{k,l}^{(p,μ)} on following equation:
$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I \\ 12 * n + {k}^{′} + Δ , configration type II\end{matrix} \\ {k}^{′} = 0 , 1 , 2 , 3 \\ c = \{ \begin{matrix}0 & when {k}^{′} = 0 , 1 \\ 4 & when {k}^{′} = 2 , 3\end{matrix} \\ l = \overline{l} + {l}^{′} \\ n = 0 , 1 … \\ j = 0 , 1 , … , v - 1\end{matrix}$$
wherein k is an index of resource elements or subcarrier, b is associated with the number of CDM groups or the configured DMRS type, k′ represents DMRS mapping parameter, n represents different times of DMRS mapping for the same CDM group, Δ is associated to an index of a CDM group or a DMRS port, w_{f}(k′) and w_{f}(l′) are OCC parameters in frequency domain and time domain, and r(4*n +k′) is the resource sequence of the DMRS port.

7. A method of wireless communication, comprising:
transmitting, by a network device to a communication device a reference signal indication;
wherein the reference signal indication indicates a plurality of resources that enable the communication device to demodulate the reference signal.

8. The method of claim 7,
wherein the plurality of resources are associated with at least one of: a generated sequence, a resource element or the subcarrier in a frequency domain, a demodulation reference signal (DMRS) port, a number of orthogonal DMRS ports in one code division multiplexing (CDM) group, a total number of orthogonal DMRS ports for all CDM groups, a configured DMRS type, an orthogonal cover code (OCC) length, resource elements offset in one CDM group, an OCC related information in the frequency domain, or an OCC related information in the time domain, and
wherein the DMRS port are supported as DMRS type 1 and DMRS type 2.

9. The method of claim 8,
wherein the generated sequence is based on r(x*n+k′),
wherein x and k′ are associated with at least one of: the number of orthogonal DMRS ports in one CDM group, the OCC length in the frequency domain, the total number of DMRS ports for all the CDM groups in one OFDM symbol, or a DMRS port index,
wherein the number of orthogonal DMRS ports in one CDM group or the OCC length in the frequency domain is 4, and
wherein the generated sequence is further generated according to r(4*n+k′).

10. The method of claim 7,
wherein the resource element or the subcarrier in the frequency domain is determined based on an equation: k=a*n+b*k′+c+Δ,
wherein k is an index of the resource elements or the subcarriers, a and b are associated with the number of CDM groups or the number of DMRS ports or the configured DMRS type, k′ and Δ are associated with a DMRS port index or a CDM group index, n is a serial integer from 0,
wherein the parameters are further determined from at least one of: for DMRS type 1, frequency domain orthogonal cover codes (FD-OCC) length is 4, a=8, b=2, c=0, then Δ=0 for the first CDM group and Δ=1 for the second CDM group, or for DMRS type 2, FD-OCC length is 4, a=12, b=1, c=0 or 4, then Δ=0 for the first CDM group, Δ=2 for the second CDM group, and Δ=4 for the third CDM group,
wherein k′ is presented as k′=0,1,2,3 when FD-OCC length is 4, and
wherein for DMRS type 2, c=0 is associated with k′=0,1 and c=4 is associated with k′=2,3.

11. The method of claim 10, wherein n is represented as n=0,1, . . . , floor(numberofREs/a)−1; or n=0,1, . . . ,ceil(numberofREs/a−1); and
wherein the numberofREs is at least one of: a total number of resource elements or subcarriers for an uplink or downlink transmission scheduling, a total number of resource elements in a precoding resource block group (PRG), a total number of resource elements or subcarriers for an uplink or downlink transmission scheduling, or a total number of resource elements in a precoding resource block group (PRG) except for the last plurality resource elements.

12. The method of claim 9, wherein the resource element or the subcarrier in the frequency domain is mapped to the intermediate quantity a_{k,l}^{(p,μ)} on following equation:
$$\begin{matrix}{a}_{k , l}^{( p , μ )} = {w}_{f} ( {k}^{′} ) {w}_{t} ( {l}^{′} ) r ( 4 * n + {k}^{′} ) \\ k = \{ \begin{matrix}8 * n + {k}^{′} + Δ , configration type I \\ 12 * n + {k}^{′} + Δ , configration type II\end{matrix} \\ {k}^{′} = 0 , 1 , 2 , 3 \\ c = \{ \begin{matrix}0 & when {k}^{′} = 0 , 1 \\ 4 & when {k}^{′} = 2 , 3\end{matrix} \\ l = \overline{l} + {l}^{′} \\ n = 0 , 1 … \\ j = 0 , 1 , … , v - 1\end{matrix} ,$$
wherein k is an index of resource elements or subcarrier, b is associated with the number of CDM groups or the configured DMRS type, k′ represents DMRS mapping parameter, n represents different times of DMRS mapping for the same CDM group, Δ is associated to an index of a CDM group or a DMRS port, w_{f}(k′) and w_{f}(l′) are OCC parameters in frequency domain and time domain, and r(4*n+k′) is the resource sequence of the DMRS port.

13. A communication apparatus comprising a processor configured to implement a method, the processor configured to:
receive, by a communication device, a reference signal indication; and
demodulate, by the communication device, the reference signal based on a plurality of resources associated with the reference signal indication.

14. The communication apparatus of claim 13,
wherein the plurality of resources are associated with at least one of: a generated sequence, a resource element or a subcarrier in a frequency domain, a demodulation reference signal (DMRS) port, a number of orthogonal DMRS ports in one code division multiplexing (CDM) group, a total number of orthogonal DMRS ports for all CDM groups, a configured DMRS type, an orthogonal cover code (OCC) length, resource elements offset in one CDM group, an OCC related information in the frequency domain, or an OCC related information in the time domain, and
wherein the DMRS port is supported as DMRS type 1 and DMRS type 2.

15. The communication apparatus of claim 14,
wherein the generated sequence is based on r(x*n+k′),
wherein x and k′ are associated with at least one of: the number of orthogonal DMRS ports in one CDM group, the OCC length in the frequency domain, the total number of DMRS ports for all the CDM groups in one OFDM symbol, or a DMRS port index,
wherein the number of orthogonal DMRS ports in one CDM group or the OCC length in the frequency domain is 4, and
wherein the generated sequence is further generated according to r(4*n+k′).

16. The communication apparatus of claim 13,
wherein the resource element or the subcarrier in the frequency domain is determined based on an equation: k=a*n+b*k′+c+4,
wherein k is an index of the resource elements or the subcarriers, a and b are associated with the number of CDM groups or the number of DMRS ports or the configured DMRS type, k′ and Δ are associated with a DMRS port index or a CDM group index, n is a serial integer from 0,
wherein the parameters are further determined from at least one of: for DMRS type 1, frequency domain orthogonal cover codes (FD-OCC) length is 4, a=8, b=2, c=0, then Δ=0 for the first CDM group and Δ=1 for the second CDM group, or for DMRS type 2, FD-OCC length is 4, a=12, b=1, c=0 or 4, then Δ=0 for the first CDM group, Δ=2 for the second CDM group, and Δ=4 for the third CDM group,
wherein k′ is presented as k′=0,1,2,3 when FD-OCC length is 4, and
wherein for DMRS type 2, c=0 is associated with k′=0,1 and c=4 is associated with k′=2,3.

17. A communication apparatus comprising a processor configured to implement a method, the processor configured to:
transmit, by a network device to a communication device a reference signal indication;
wherein the reference signal indication indicates a plurality of resources that enable the communication device to demodulate the reference signal.

18. The communication apparatus of claim 17,
wherein the plurality of resources are associated with at least one of: a generated sequence, a resource element or the subcarrier in a frequency domain, a demodulation reference signal (DMRS) port, a number of orthogonal DMRS ports in one code division multiplexing (CDM) group, a total number of orthogonal DMRS ports for all CDM groups, a configured DMRS type, an orthogonal cover code (OCC) length, resource elements offset in one CDM group, an OCC related information in the frequency domain, or an OCC related information in the time domain, and
wherein the DMRS port are supported as DMRS type 1 and DMRS type 2.

19. The communication apparatus of claim 18,
wherein the generated sequence is based on r(x*n+k′),
wherein x and k′ are associated with at least one of: the number of orthogonal DMRS ports in one CDM group, the OCC length in the frequency domain, the total number of DMRS ports for all the CDM groups in one OFDM symbol, or a DMRS port index,
wherein the number of orthogonal DMRS ports in one CDM group or the OCC length in the frequency domain is 4, and
wherein the generated sequence is further generated according to r(4*n+k′).

20. The communication apparatus of claim 17,
wherein the resource element or the subcarrier in the frequency domain is determined based on an equation: k=a*n+b*k′+c+4,
wherein k is an index of the resource elements or the subcarriers, a and b are associated with the number of CDM groups or the number of DMRS ports or the configured DMRS type, k′ and Δ are associated with a DMRS port index or a CDM group index, n is a serial integer from 0,
wherein the parameters are further determined from at least one of: for DMRS type 1, frequency domain orthogonal cover codes (FD-OCC) length is 4, a=8, b=2, c=0, then Δ=0 for the first CDM group and Δ=1 for the second CDM group, or for DMRS type 2, FD-OCC length is 4, a=12, b=1, c=0 or 4, then Δ=0 for the first CDM group, Δ=2 for the second CDM group, and Δ=4 for the third CDM group,
wherein k′ is presented as k′=0,1,2,3 when FD-OCC length is 4, and
wherein for DMRS type 2, c=0 is associated with k′=0,1 and c=4 is associated with k′=2,3.
